(19) United States
(12) Patent Application Publication
(10) Pub. No.: US 2008/0314300 A1
(43) Pub. Date: Dec. 25, 2008

(54) Spreader Disengagement Plate and Method of Use Thereof

(75) Inventor: Neil Edwin Bowsher, Sullivan, IL (US)

Correspondence Address: VEDDER PRICE P.C., 222 N. LASALLE STREET, CHICAGO, IL, 60601, US

(73) Assignee: AGRI-FAB, INC., Sullivan, IL (US)

(21) Appl. No.: 11/765,603

(22) Filed: Jun. 20, 2007

(51) Int. Cl. A01C 19/04; A01C 7/20; A01C 7/16

(52) U.S. Cl. 111/11; 222/623; 111/130

(57) ABSTRACT

The present disclosure relates to the spreading system of broadcast spreaders, and in particular, to a spreader disengagement plate and method of use thereof for selectively engaging a rotatable spreader plate by coupling and uncoupling the different elements of a drive mechanism. A folded, U-shaped metal disengagement plate having a central pivot is connected to an axle. By pushing on either end of the pivoting disengaging plate, a user rotates the disengagement plate from an open configuration to a locked configuration and back. When in an open configuration, the disengagement plate remains immobile while the broadcast spreader is moved. When in the locked configuration, the disengagement plate rotates in conjunction with the wheel. In one embodiment, a lock nut is placed on the external surface of the wheel hub and must be inserted within the folded, U-shaped metal disengagement plate in the locked configuration.

### FIELD OF THE DISCLOSURE

The present disclosure relates to a drive assembly of a broadcast spreader for seeds, granular material, and other loose material, and in particular, to a spreader disengagement plate and method of use thereof to selectively engaging a rotatable spreader plate used to distribute seeds, granular material, and other loose material on a selected surface.

### BACKGROUND

Broadcast spreaders are used to disperse seeds, granular material, and other loose material (hereinafter, “material”) over a generally horizontal surface. A large volume of material to be dispersed, generally purchased in a bag or canister, is emptied into a receptacle called a “hopper.” Portable broadcast spreaders may be operated manually by a single user who pushes a device equipped with wheels, a frame, and a handle bar.

In order to spread material over the surface, broadcast spreaders are equipped with distribution systems generally located under the hopper where gravity is the driving force behind the flow of the material through an opening in the hopper and trough to a distribution system. In one type of broadcast spreader, a variable area of the bottom opening in the hopper is controlled by the user to regulate the flow of material to the distribution system.

Some distribution systems, such as chalk line machines used on sports fields, distribute the flow of material along a line of variable width where a cage having circumferentially placed fixed volumes rotates below the opening. Other distribution systems used in connection with grass seed spread material over an area around the machine using a rotating horizontal plate equipped with ribs capable of redirecting the flow of material using centrifugal energy. Examples of portable broadcast spreaders include conventional fertilizer dispensers, salt spreaders, and seed dispensers.

Most distribution systems must be driven by an external force to distribute the material. In one embodiment, a gear box allows for the transformation of hopper displacement energy (i.e., movement over a horizontal surface) to the distribution system. For example, a horizontal axle placed within and between wheels on the frame can be coupled with the wheels to rotate the axle, which in turns activates a gear box connected to the axle and the distribution system.

As a result of this direct coupling, the faster the broadcast spreader is moved over a horizontal surface, the faster the wheels rotate and the faster the broadcast spreader plate rotates via the gear box. Faster rotation of the spreader plate implies distribution of material at a greater distant from the broadcast spreader since centrifugal force is increased. In the field of broadcast spreaders, simplicity, durability, and resistance to environmental conditions are important advantages. Broadcast spreaders are used over rough terrain and are stored in sheds, garages, and the open air, sometimes in rainy or snowy conditions. Salt spreaders are used during snowstorms over slushy and wet conditions by operators who wear winter gear or other types of protective gear.

Current broadcast spreaders provide an assembly to directly couple a drive mechanism to the wheels of the broadcast spreaders. In the prior art, as illustrated in FIGS. 1 and 2, the drive mechanism is coupled when a hole drilled in a central axle is aligned by an operator with one or two holes made in the body of the wheel and a pin is inserted in the aligned holes. The user must then remove the pin and a lock pin when the drive mechanism is to be decoupled from the motion of the wheels. One of the disadvantages of this prior art system is the need to store the lock pin and the pin between uses when the spreading system is uncoupled. Another obvious disadvantages is best understood using a winter salt spreader during a snowstorm. Operators wear gloves or mitts and must remove this gear to access the lock pin stored in their pocket. In addition, snow accumulated inside the wheel must be cleared from the hole. Nocturnal use of these broadcast spreaders often make the step of aligning the hole in the axle with the hole in the wheel almost impossible.

Therefore, there is a need in the art for an improved system for coupling the different portions of a distribution system of a broadcast spreader that does not require the removal or insertion of loose parts and that can be conducted with ease under any environmental conditions, including nocturnal use.

### SUMMARY

The present disclosure relates to the spreading assembly of broadcast spreaders, and in particular, to an spreader disengagement plate and method of use thereof for selectively engaging a rotatable spreader plate by coupling and uncoupling the different elements of a drive mechanism. A disengagement plate includes a pivot and is connected to an axle. By pushing a section on either end of the pivoting disengaging plate, a user rotates the disengagement plate from an open configuration to a locked configuration. The disengagement plate locks in place over a notch or a tab located on the wheel.

When the disengagement plate in an open configuration, the disengagement plate does not rotate along with the wheels and the plate remains immobile. In the locked configuration, the disengagement plate rotates in conjunction with the wheel. In one embodiment, a lock nut is placed on the external surface of the wheel hub and must be inserted within the disengagement plate in the locked configuration.

### BRIEF DESCRIPTION OF THE DRAWINGS

Certain embodiments are shown in the drawings. However, it is understood that the present disclosure is not limited to the arrangements and instrumentality shown in the attached drawings.

FIG. 1 is an exploded elevation view of a first device in an open configuration from the prior art where a pin and a lock pin are not inserted into the axle assembly.

FIG. 2 is an elevation view of the device of FIG. 1 in a locked configuration from the prior art where the pin and the lock pin are inserted into the axle assembly.

FIG. 3 is a partial elevation view of the axle assembly and wheel of a broadcast spreader in an open configuration according to a first embodiment of the present disclosure.

FIG. 4 is a partial elevation view of the axle assembly and wheel of the broadcast spreader of FIG. 3 in a locked configuration according to the first embodiment of the present disclosure.

FIG. 5 is a perspective view of the broadcast spreader for distributing material with a disengagement plate according to another embodiment of the present disclosure where the disengagement plate is shown in the locked configuration.

FIG. 6 is perspective detail view of the pivoting element of the spreader disengagement plate where the locked configuration is shown in full lines and the open configuration is shown in shadow lines according to an embodiment of the present disclosure.

FIG. 7 is a perspective detail view of the spreader disengagement plate according to a an embodiment of the present disclosure.

FIG. 8 is a functional diagram of the drive mechanism of the broadcast spreader as shown in FIG. 5 according to an embodiment of the present disclosure.

FIG. 9 is a diagram illustrating the steps of a method for spreading material over a surface using a broadcast spreader.

### DETAILED DESCRIPTION

For the purposes of promoting and understanding the principles disclosed herein, reference is now made to the preferred embodiments illustrated in the drawings and specific language is used to describe the same. It is nevertheless understood that no limitation of the scope is thereby intended. Such alterations and further modifications of the illustrated devices and such further applications of the principles disclosed as illustrated herein are contemplated as would normally occur to one skilled in the art to which this disclosure relates.

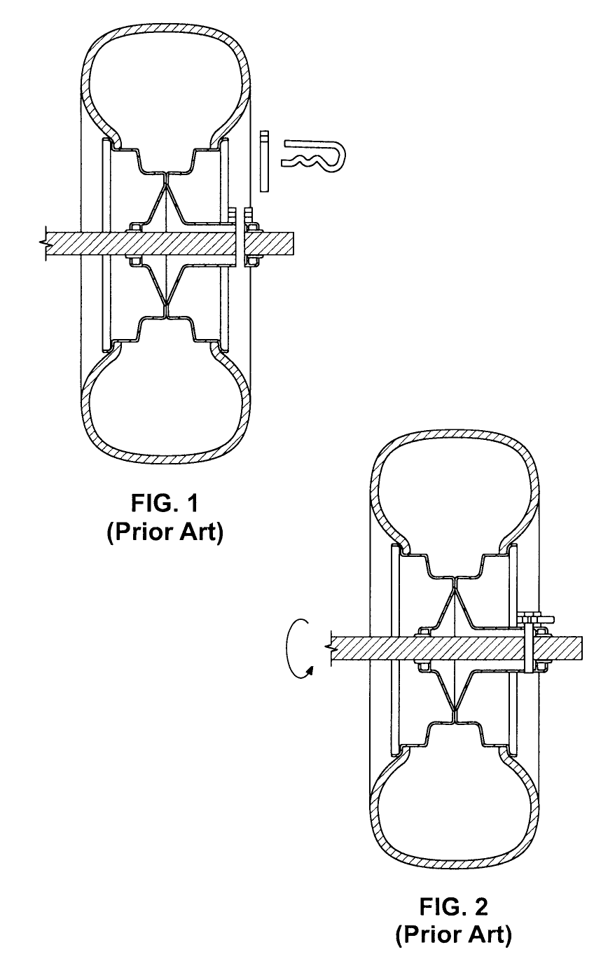

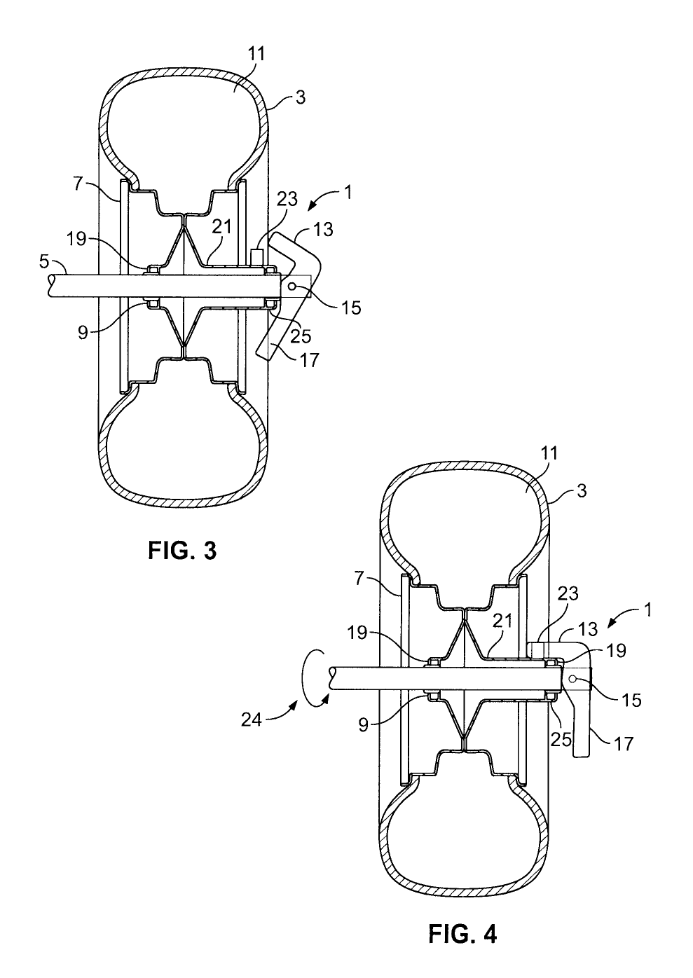

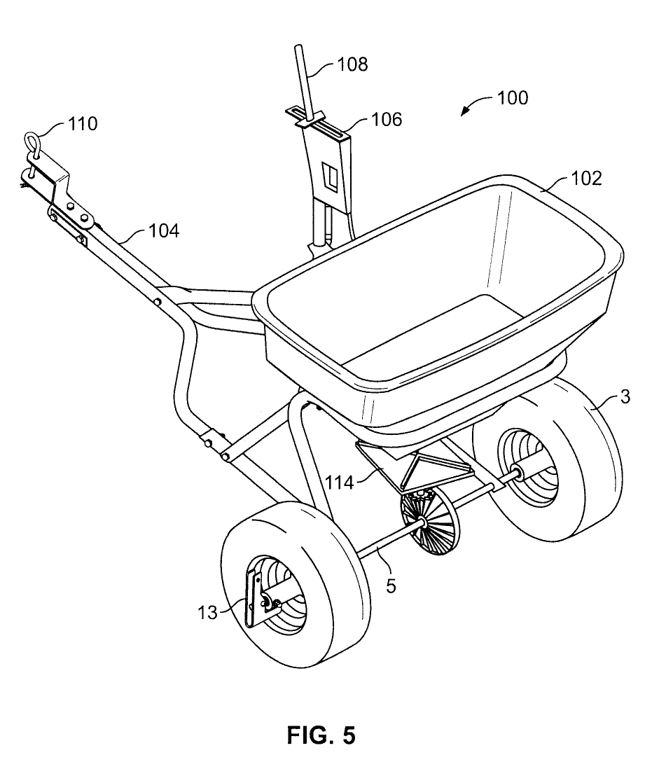

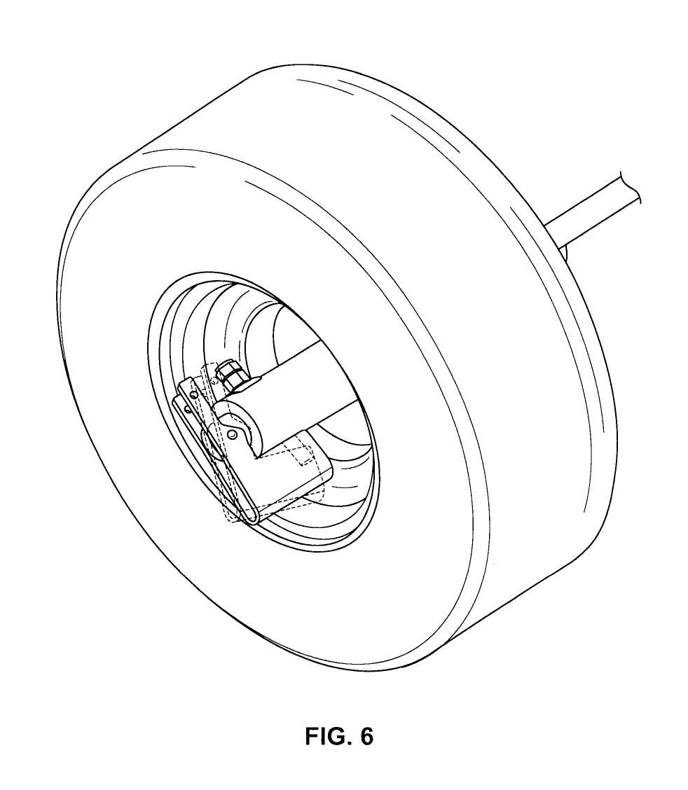

The prior art shown in FIGS. 1-2 teaches the use of a broadcast spreader having a pin and a lock pin that may be inserted and aligned with a hole in an axle assembly that must be aligned with a hole of adequate and sufficient geometry in the wheel to house the pin. The pin operatively connects the axle assembly to the wheel and, as a result, when the broadcast spreader is propelled and the wheels turn, the axle assembly that is coupled with the drive assembly results in the rotation of the spreading system. FIG. 8 illustrates the general principle of the rotational coupling between the axle assembly 5 and the material 160 located within the hopper 102 where the spreader disengagement plate 13 is shown in locked configuration. Wheels 3 are rotated by pushing a frame 104 as shown in FIG. 5. Returning to FIG. 8, if the axle assembly 5 is locked to the wheels 3 by rotating 24 the spreader disengagement plate 13, then the rotational movement 74 of the axle assembly 5 engages a mechanism shown as a series of gears 70, 72 designed to impart rotational displacement in a perpendicular direction 96 to the rotational movement 74 of the axle assembly 5. One of ordinary skill in the art recognizes that a wide variety of drive mechanisms are contemplated and only one preferred embodiment having a series of gears is shown. Other means include but are not limited to the use of belts, electrically activated means, detectors, and the like.

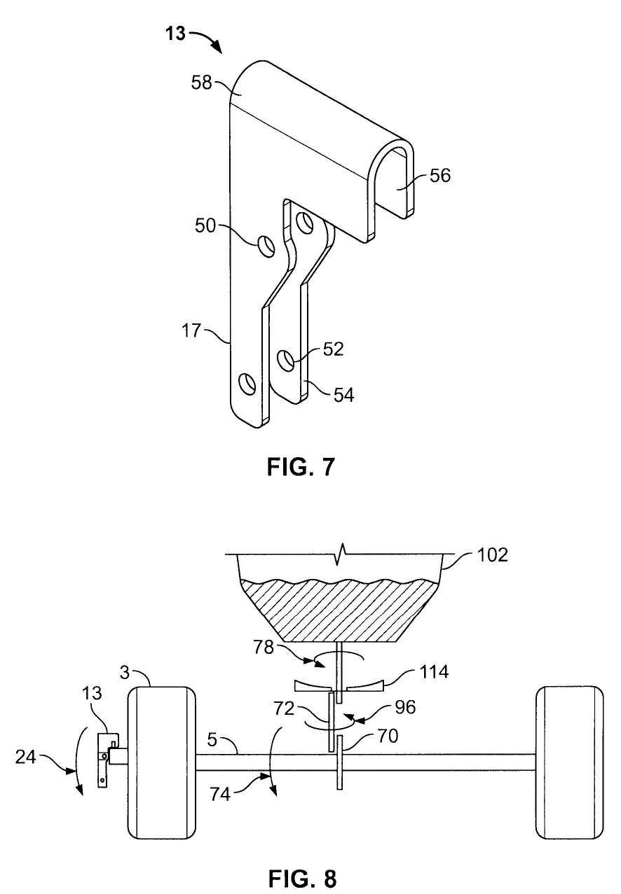

In one embodiment shown in FIG. 6, the spreader disengagement plate 13 is pivotally attached to the wheel at a midpoint 50. FIG. 6 is a perspective detail view of the pivoting element of the spreader disengagement plate illustrating a locked position in solid lines and an open position in dashed lines. What is shown is a U-shaped spreader disengagement plate 13 capable of engaging with the U-shaped top 58 as shown in FIG. 7 a lock tab 23.

FIG. 5 illustrates in perspective view the broadcast spreader 100 for distributing material 160 as shown in FIG. 8 in one contemplated configuration. The hopper 102 as shown is empty of material 160. In one embodiment, the broadcast spreader 100 includes two wheels 3 attached by an axle assembly 5 and a frame 104. The frame 104 is pivotally is attached to the axle assembly 5 but could also be attached directly or indirectly to the rims inside the wheels 3. The frame 104 also includes a vehicle back end attachment 110 and a handle 108 for opening and closing an opening (not shown) in the hopper 102 to allow material 160 to pour out onto the spreader system 114 by sliding the handle 108 between two positions on a sliding mechanism 106. One of ordinary skill in the art recognizes that a wide variety of broadcast spreaders 100 having different types of frames 104 using different material 160 holding mechanisms and used either manually or with vehicles is contemplated.

FIG. 3 is an elevation of the axle assembly 5 and wheel 3 of a broadcast spreader 100 in an open configuration according to one possible embodiment. FIG. 4 illustrates the same partial elevation of the axle assembly 5 and wheel 3 of the broadcast spreader 100 but in a closed configuration where the axle assembly is made to rotate 24 along with any rotation of the wheel 3 (not shown). In one illustrated example, the wheel 3 includes a tire 11 having an internal portion and a rim 7 made of metal. The rim 7 holds the axle assembly 5 at two ends 9, 25 where friction control devices are placed 19. In one preferred embodiment, bearing cages are used as friction control devices. While one particular embodiment is shown, one of ordinary skill in the art recognizes that other devices, such as friction pads, lubricants, and smooth surface finishes, can also be used.

The axle assembly 5 as shown includes a pivot attachment 15 where the spreader disengagement plate 13 is attached pivotally and can be rotated using a light push, such as a foot pressure. The external surface of the wheel 21 includes a lock tab 23 designed for operational contact with the spreader disengagement plate 13. In one contemplated embodiment, the disengagement plate 13 is U-shaped and the lock tab 23 as shown in FIG. 4 can be mated with the U-shaped section. The spreader disengagement plate 13 also includes a first push section 72 and a second push section 17.

Also disclosed is a broadcast spreader 100 for distributing material 160. The broadcast spreader 100 for distributing where the material 160 is disposed inside a hopper 102. A frame 104 supports the hopper 102 and includes at least a wheel 3 with a lock tab 23 as shown in FIGS. 3-4. The wheel 3 is rotatably connected to the frame 104 so the broadcast spreader 100 can be propelled over a surface. An axle assembly 5 has a first end 25 with a pivotally connected 15 disengagement plate 13 and a support section 76 rotatably connected to the wheel 3. The broadcast spreader 100 also includes a rotatable spreader plate 114 located below the hopper 102 to spread the material 160 rotating as a result of the wheel 3 being propelled over the surface and driving the axle assembly 5. The disengagement plate 13 also includes a tab holder 56 shown in FIG. 7 as a U-shaped bend 58. The disengagement plate 13 also includes a pivot 50 for pivoting between an open configuration as shown in FIG. 4 and a locked configuration as shown in FIG. 3. The wheel 3 drives the axle assembly 5 when the disengagement plate 13 is pivoted in the locked configuration so the tab holder 56 is in physical connection with the lock tab 23.

Additionally contemplated is a disengagement plate 13 where a first push section 72 and a second push section 17 are located in opposition on each side of the pivot 15. These push sections 72, 17 allow for easy engagement and disengagement of the disengagement plate 13 between the locked configuration shown in FIG. 3 and the open configuration shown in FIG. 4. While a manual device is shown, what is also contemplated is any mechanical, electrical, or automatically activated system that allows the user of the broadcast spreader 100 to pivot the disengagement plate 13 between the open configuration and the locked configuration. In order to pivot the disengagement plate 13 from an open configuration to a locked configuration, a push must be made on the first push section 72. Alternatively, to pivot the disengagement plate 13 from the locked configuration to the open configuration, a push must be made on the second push section 17. In one preferred embodiment, the pushes on the first or the second push sections 72, 17 are made by the user's foot.

In one embodiment, the lock tab 23 located on the wheel 3 is a bolt or a series of bolts attached to the rim 7 of the wheel. The bolt is designed to mate with a U-shaped bend 58 of the disengagement plate 13. What is also contemplated but not shown is the creation in the bent disengagement plate 13 of an opening that allows for the lock tab 23 to rotate inside the U-shaped bend 58. While one possible locking configuration is shown, what is contemplated is any locking configuration of the disengagement plate 13 with the lock tab 23. What is also contemplated is the creation of rims on the wheel with a geometry that allows for the disengagement plate it partly connect with the rim 7 in order to lock the disengagement plate 13 in the locked configuration.

In one contemplated embodiment, the broadcast spreader 100 also includes a friction stop associated with the pivot 50 of the disengagement plate 13 for maintaining the disengagement plate 13 in either the locked configuration or the open configuration absent external forces. One of ordinary skill in the art recognizes that adequate friction must be placed on the pivot 50 to prevent undesired release of the lock tab 23 by the disengagement plate 13 when the wheel is rotated during operation. What is also desired is for the disengagement plate 13, when placed in the open configuration, to not pivot back in the locked configuration based on movements created by gravitational or rotation forces.

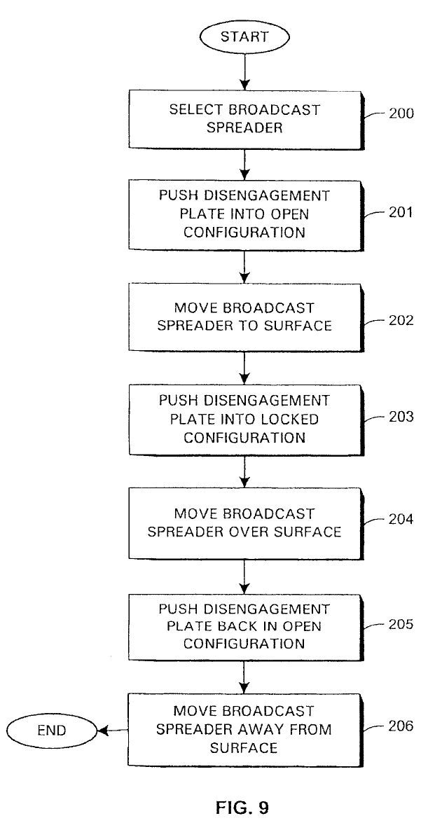

FIG. 9 is a diagram illustrating the steps of a method for spreading material 160 over a surface using a broadcast spreader 100. The method including the successive steps of selecting 200 a broadcast spreader 100 having a hopper 102 containing a material 160, a frame 104 for supporting the hopper 102, a wheel 3 with a lock tab 23 rotatably connected to the frame 104 so the broadcast spreader 100 can be moved over a surface, an axle assembly 5 having a first end 25 with a pivotally connected disengagement plate 13 and a support section 76 rotatably connected to the wheel 3, and a rotatable spreader plate 114 located below the hopper 102 to spread the material 160 resulting from the wheel 3 being moved over the surface and driving the axle assembly 5. The disengagement plate 13 also includes a tab holder 56 and a pivot 50 for pivoting between an open configuration and a locked configuration, and the wheel 3 drives the axle assembly 5 when the disengagement plate 13 is rotated in the locked configuration so the tab holder 56 is in physical contact with the lock tab 23. The method also includes the steps of pushing 201 the disengagement plate 13 in the open configuration as shown in FIG. 3, moving 202 the broadcast spreader 100 to a surface for spreading material 160, pushing 203 the disengagement plate 13 in the locked configuration, and moving 204 the broadcast spreader 100 over a surface for spreading material 160.

In an alternate embodiment, the method further includes the steps of pushing 205 the disengagement plate 13 in the open configuration, placing a foot over a first section 72 of the disengagement plate 13, and applying pressure on the first section 72. In another embodiment, the step of pushing 203 the disengagement plate 13 in the locked configuration is made by placing a foot over a second section 17 of the disengagement plate and applying pressure on the second section 17. In yet another embodiment, the method further comprises the step of pushing 205 the disengagement plate 13 into the open configuration and moving 206 the broadcast spreader 100 away from the surface for spreading material 160.

Persons of ordinary skill in the art appreciate that although the teachings of the disclosure have been illustrated in connection with certain embodiments and method, there is no intent to limit the invention to such embodiments and methods. On the contrary, the intention of this application is to cover all modifications and embodiments failing fairly within the scope of the teachings of the disclosure.

1. A broadcast spreader for distributing material disposed therein, the spreader comprising:
a hopper containing a material;
a frame for supporting the hopper;
a wheel with a lock tab rotatably connected to the frame so the broadcast spreader can be moved over a surface;
an axle assembly having a first end with a pivotally connected disengagement plate and a support section rotatably connected to the wheel; and
a rotatable spreader plate located below the hopper to spread the material rotating as a result of the wheel being moved over the surface and driving the axle assembly;
wherein the disengagement plate comprises a tab holder and a pivot for pivoting between an open configuration and a locked configuration, and wherein the wheel drives the axle assembly when the disengagement plate is rotated in the locked configuration so the tab holder is in physical connection with the lock tab.

2. The broadcast spreader of claim 1, wherein the disengagement plate further comprises a first push section and a second push section in opposition on each side of the pivot.

3. The broadcast spreader of claim 2, wherein the disengagement plate is pivoted from the open configuration to the locked configuration by pushing on the first push section.

4. The broadcast spreader of claim 2, wherein the disengagement plate is pivoted from the locked configuration to the open configuration by pushing on the second push section.

5. The broadcast spreader of claim 3, wherein the disengagement plate is pushed from the open configuration to the locked configuration by a foot of a user of the broadcast spreader.

6. The broadcast spreader of claim 4, wherein the disengagement plate is pushed from the locked configuration to the open configuration by a foot of a user of the broadcast spreader.

7. The broadcast spreader of claim 1, wherein the lock tab is a bolt attached to a rim of the wheel.

8. The broadcast spreader of claim 1, wherein the tab holder is a folded, U-shaped configuration where the lock tab is inserted inside of the U shape when the disengagement plate is pushed in the locked configuration.

9. The broadcast spreader of claim 1, wherein the pivot includes a friction stop for maintaining the disengagement plate in either the locked configuration or the open configuration absent external forces.

10. A method for spreading material over a surface using a broadcast spreader, the method comprising the steps of:
selecting a broadcast spreader having a hopper containing a material, a frame for supporting the hopper, a wheel with a lock tab rotatably connected to the frame so the broadcast spreader can be moved over a surface, an axle assembly having a first end with a pivotally connected disengagement plate and a support section rotatably connected to the wheel, and a rotatable spreader plate located below the hopper to spread the material rotating as a result of the wheel being moved over the surface and driving the axle assembly, wherein the disengagement plate comprises a tab holder and a pivot for pivoting between an open configuration and a locked configuration, and wherein the wheel drives the axle assembly when the disengagement plate is rotated in the locked configuration so the tab holder is in physical contact with the lock tab;
pushing the disengagement plate in the open configuration;
moving the selected broadcast spreader to a surface for spreading material;
pushing the disengagement plate in the locked configuration; and
moving the selected broadcast spreader over the surface for spreading material.

11. The method of claim 10, wherein the step of pushing the disengagement plate in the open configuration is made by placing a foot over a first section of the disengagement plate and applying pressure on the first section.

12. The method of claim 10, wherein the step of pushing the disengagement plate in the locked configuration is made by placing a foot over a second section of the disengagement plate and applying pressure on the second section.

13. The method of claim 10, wherein the method further comprises the steps of pushing the disengagement plate back in the open configuration and moving the broadcast spreader away from the surface for spreading material.
